(19) United States
(12) Patent Application Publication
(10) Pub. No.: US 2015/0363367 A1
(43) Pub. Date: Dec. 17, 2015

(54) DISPLAY PROCESSING DEVICE, DISPLAY PROCESSING METHOD, AND COMPUTER PROGRAM PRODUCT

(71) Applicants: KABUSHIKI KAISHA TOSHIBA, Tokyo (JP); TOSHIBA SOLUTIONS CORPORATION, Kawasaki-shi (JP)

(72) Inventors: Toshimasa Dobashi, Kawasaki (JP); Hiroyuki Mizutani, Yokohama (JP)

(21) Appl. No.: 14/837,193

(22) Filed: Aug. 27, 2015

Related U.S. Application Data
(63) Continuation of application No. PCT/JP2013/055558, filed on Feb. 28, 2013.

(51) Int. Cl. G06F 17/21; G06F 3/0485

(52) U.S. Cl. CPC G06F 17/212; G06F 3/0485

(57) ABSTRACT

According to an embodiment, a display processing device includes a reader and a display controller. The reader is configured to read content data that is to be displayed on a display. The display controller is configured to display, on the display, virtual content data in which one end of a display target area of the content data and the other end opposite to the one end of the display target area are connected, when a width of the display target area is larger than a width of the display.

### CROSS-REFERENCE TO RELATED APPLICATION

This application is a continuation of International Application No. PCT/JP2013/055558, filed on Feb. 28, 2013, the entire contents of which are incorporated herein by reference.

### FIELD

Embodiments described herein relate generally to a display processing device, a display processing method, and a computer program.

### BACKGROUND

The popularization of mobile terminals, such as smartphones, increases opportunities to browse content data such as document data on small screens of the mobile terminals. When the whole of document data is displayed within such a small screen, characters are often displayed too small to read. Thus, in general, users browse the document data by displaying a partial area of the document data and scrolling the document data on the screen. When a row of a document fails to be fully displayed within the screen, scrolling from the end of the row to the beginning of the next row is required row by row, thereby increasing the user's burden due to scrolling operation and shifting of the visual line.

### BRIEF DESCRIPTION OF THE DRAWINGS

FIG. 1 is a schematic diagram illustrating an example of a functional block of a display processing device according to a first embodiment;

FIG. 2 is a schematic diagram for explaining an example of analysis of a document layout by the display processing device in the first embodiment;

FIG. 3 illustrates a scrolling method of a conventional display processing device when document data is browsed;

FIG. 4 is a schematic diagram for explaining traces in scrolling directions in the scrolling method described with reference to FIG. 3;

FIG. 5 illustrates an example of a scrolling method performed by the display processing device in the first embodiment when a document is browsed (in a right-left connection mode);

FIG. 6 is a schematic diagram for explaining traces in scrolling directions in the scrolling method described with reference to FIG. 5;

FIG. 7 is a flowchart for explaining a display method performed by the display processing device in the first embodiment;

FIG. 8 is a flowchart for explaining a display mode setting method performed by the display processing device in the first embodiment;

FIG. 9 is a schematic diagram for explaining a coordinate system in the display processing device in the first embodiment;

FIG. 10 is a schematic diagram for explaining an example of a right-left connection mode in the display processing device according to a second embodiment;

FIG. 11 is a flowchart for explaining a display method performed by the display processing device according to a third embodiment;

FIG. 12 is a schematic diagram for explaining an exemplary case where the display processing device in the third embodiment displays second virtual document block data in the right-left connection mode;

FIG. 13 is a schematic diagram illustrating an exemplary case where sentences in document blocks of the document data are written horizontally;

FIG. 14 is a schematic diagram illustrating an example of first virtual document block data (based on the document data illustrated in FIG. 13) produced by the display processing device in the third embodiment;

FIG. 15 is a schematic diagram illustrating an exemplary case where sentences in the document blocks of the document data are written vertically;

FIG. 16 is a schematic diagram illustrating an example of the second virtual document block data (based on the document data illustrated in FIG. 15) produced by the display processing device in the third embodiment;

FIG. 17 is a schematic diagram illustrating an exemplary case where the shape of the document block of the document data is not a rectangle;

FIG. 18 is a schematic diagram illustrating an example of the first virtual document block data (based on the document data illustrated in FIG. 17) produced by the display processing device in the third embodiment;

FIG. 19 is a schematic diagram illustrating an example of a size of a display of the display processing device in the third embodiment;

FIG. 20 is a schematic diagram illustrating an example where a plurality of document blocks having different horizontal widths are simultaneously displayed when the display processing device in the third embodiment displays the first virtual document block data;

FIG. 21 is a schematic diagram illustrating another example where a plurality of document blocks having different horizontal widths are simultaneously displayed when the display processing device in the third embodiment displays the first virtual document block data;

FIG. 22 is a schematic diagram illustrating still another example where a plurality of document blocks having different horizontal widths are simultaneously displayed when the display processing device in the third embodiment displays the first virtual document block data;

FIG. 23 is a schematic diagram illustrating an example where a plurality of document blocks having different vertical widths are simultaneously displayed when the display processing device in the third embodiment displays the second virtual document block data;

FIG. 24 is a schematic diagram illustrating another example where a plurality of document blocks having different vertical widths are simultaneously displayed when the display processing device in the third embodiment displays the second virtual document block data;

FIG. 25 is a schematic diagram illustrating still another example where a plurality of document blocks having different vertical widths are simultaneously displayed when the display processing device in the third embodiment displays the second virtual document block data; and

FIG. 26 is a schematic diagram illustrating an example of main components of a hardware structure of the display processing device in the first to the third embodiments.

### DETAILED DESCRIPTION

According to an embodiment, a display processing device includes a reader and a display controller. The reader is configured to read content data that is to be displayed on a display. The display controller is configured to display, on the display, virtual content data in which one end of a display target area of the content data and the other end opposite to the one end of the display target area are connected, when a width of the display target area is larger than a width of the display.

### First Embodiment

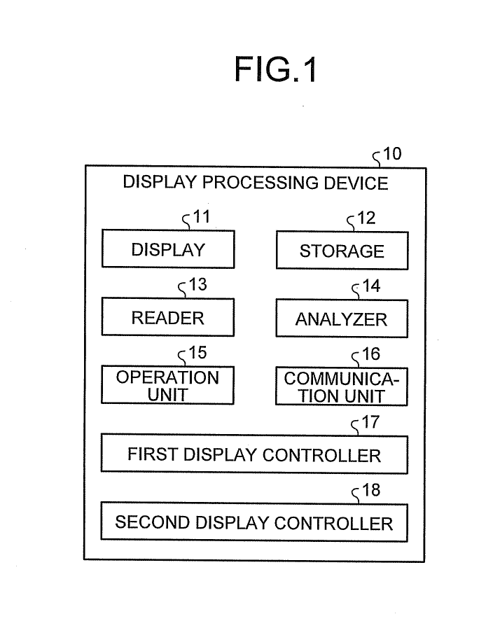

FIG. 1 is a schematic diagram illustrating an example of a functional block of a display processing device 10 in a first embodiment. The display processing device 10 in the first embodiment includes a display 11, a storage 12, a reader 13, an analyzer 14, an operation unit 15, a communication unit 16, a first display controller 17, and a second display controller 18.

The display 11 displays content data. The content data includes documents, pictures, and diagrams. Hereinafter, data including a document (characters) is described as “document data”. The document data may include diagrams besides the document. The display 11 is a liquid crystal display, for example. The storage 12 stores therein system data such as a program and user data such as the document data. The reader 13 reads the document data and document layout data. The document layout data indicates a layout of the document data when the document data is displayed on a screen. Any data format of the document layout data that can manage the layout of the document data displayed on the screen is usable. For example, the document layout data is text data. The analyzer 14 analyzes the document layout of the document data using the document layout data. The document layout data analyzed by the analyzer 14 may be produced by the display processing device 10 or may be acquired from other devices as already produced document layout data.

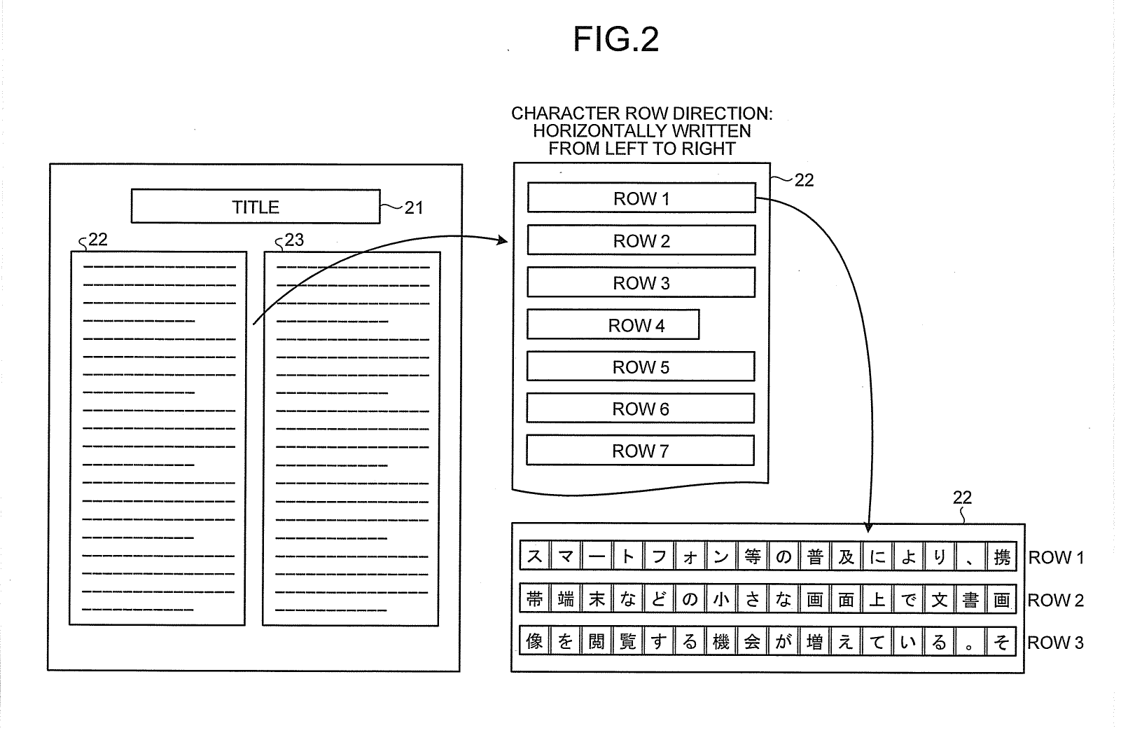

FIG. 2 is a schematic diagram for explaining an example of analysis of the document layout by the display processing device 10 in the first embodiment. FIG. 2 illustrates the example where the analyzer 14 analyzes the layout of a document as a document block 21 (title area), a document block 22 (left sentence area), and a document block 23 (right sentence area) using the document layout data. For example, the analysis result of the document block 22 by the analyzer 14 is that the document block 22 includes horizontally written sentences that can be read from left to right. The analyzer 14 further extracts character information about each sentence.

The analyzer 14 may analyze whether sentences are written horizontally or vertically using information other than the document layout data. For example, the analyzer 14 may use language identification information, font type, or landscape/portrait identification information included in the content data. The language identification information indicates, for example, of which country the language is. The analyzer 14 may use a default setting when no information is available for analyzing whether sentences are written horizontally or vertically. An example of the default setting is a setting for the display processing device 10 to perform display control when the document includes horizontally written sentences.

Referring back to FIG. 1, the operation unit 15 is an interface through which a user performs operation such as scrolling for referring to data displayed on the display 11. The operation unit 15 is a liquid crystal touch panel or a button included in the display processing device 10, for example. The communication unit 16 is an interface that transmits data to and receives data from other devices.

The first display controller 17 performs control when the number of pixels in the horizontal width of the display 11 is larger than the number of pixels in the horizontal width of a display target area of the document data, and the document included in the document data is written horizontally. The first display controller 17 displays, on the display 11, first virtual document data in which the right end and the left end of the document data, when the document data is displayed on the display 11, are connected.

The second display controller 18 performs control when the number of pixels in the vertical width of the display 11 is larger than the number of pixels in the vertical width of the display target area of the document data, and the document included in the document data is written vertically. The second display controller 18 displays, on the display 11, second virtual document data in which the top and the bottom of the document data, when the document data is displayed on the display 11, are connected.

The display processing device 10 in the first embodiment performs the display control by the two display controllers of the first display controller 17 and the second display controller 18. The first display controller 17 and the second display controller 18 may be achieved by a single display controller.

The following describes a scrolling method performed by the display processing device 10 in the first embodiment when the document data is browsed. The display processing device 10 in the first embodiment has a connection display mode that reduces the user's burden besides a normal display mode in which the document data is displayed without any change in style (no change is performed except for magnification and reduction). In the connection display mode, a virtual display is performed in such a manner that both end sides of the document data when the document data is displayed are connected to each other. The connection display mode has a right-left connection mode and a top-bottom connection mode. For clearly describing the difference in scrolling method between the display processing device in the first embodiment and conventional display processing devices, the following description is made about the scrolling method of an exemplary conventional display processing device.

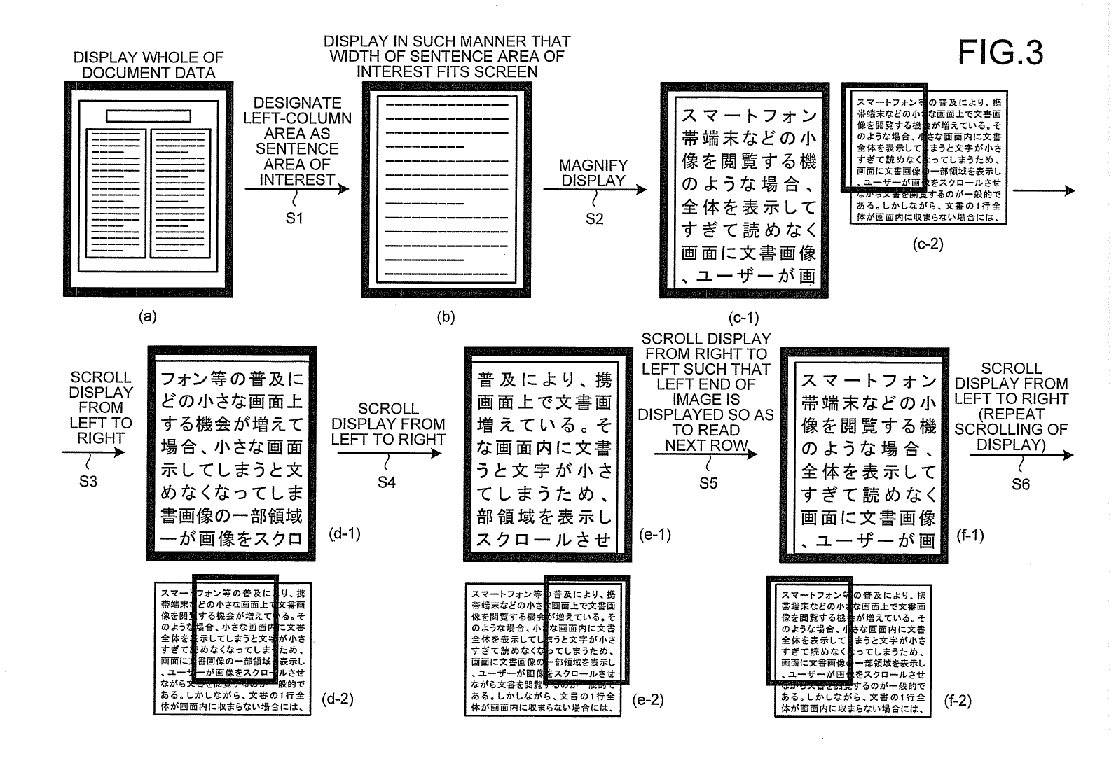

FIG. 3 illustrates a scrolling method of a conventional display processing device when the document data is browsed. Specifically, FIG. 3 illustrates an example where the document data is composed of a title and a two-column document. The following describes an example where a user browses a left-column area (left document block).

The conventional display processing device displays the left-column area in accordance with the user's operation to designate a display area (to designate the left-column area to a sentence area of interest) (step S1). The conventional display processing device displays in such a manner that the width of the sentence area of interest fits the screen. The conventional display processing device magnifies the display of the sentence area of interest in accordance with the user's operation to magnify the sentence area of interest (step S2). In FIG. 3, (c-1) illustrates that a part of the document data illustrated in (c-2) is displayed on the screen. The conventional display processing device scrolls the display of the sentence area of interest from left to right in accordance with the user's operation to read a sentence (step S3). The conventional display processing device further scrolls the display of the sentence area of interest from left to right in accordance with the user's operation to further read the sentence (step S4). The conventional display processing device scrolls the display of the sentence area of interest from right to left in accordance with the user's operation to further read the sentence from the end of the first row to the beginning of the second row (step S5). The conventional display processing device repeats the operation (from step S3 to step S5) (step S6).

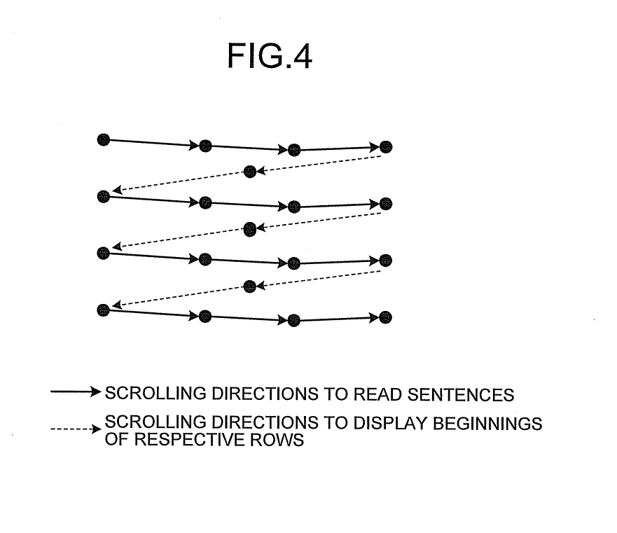

FIG. 4 is a schematic diagram for explaining traces in scrolling directions in the scrolling method described with reference to FIG. 3. The solid arrows indicate the scrolling directions to read sentences. The dotted arrows indicate the scrolling directions to display the beginnings of respective rows. In this way, the document can be continuously read by repeating the scrolling horizontally. The scrolling operation, however, increases the user's burden. In addition, the shifting of the visual line from the right end to the left end of the display screen, which is required when the reading is continued from the end of the row to the beginning of the next row, increases the user's burden.

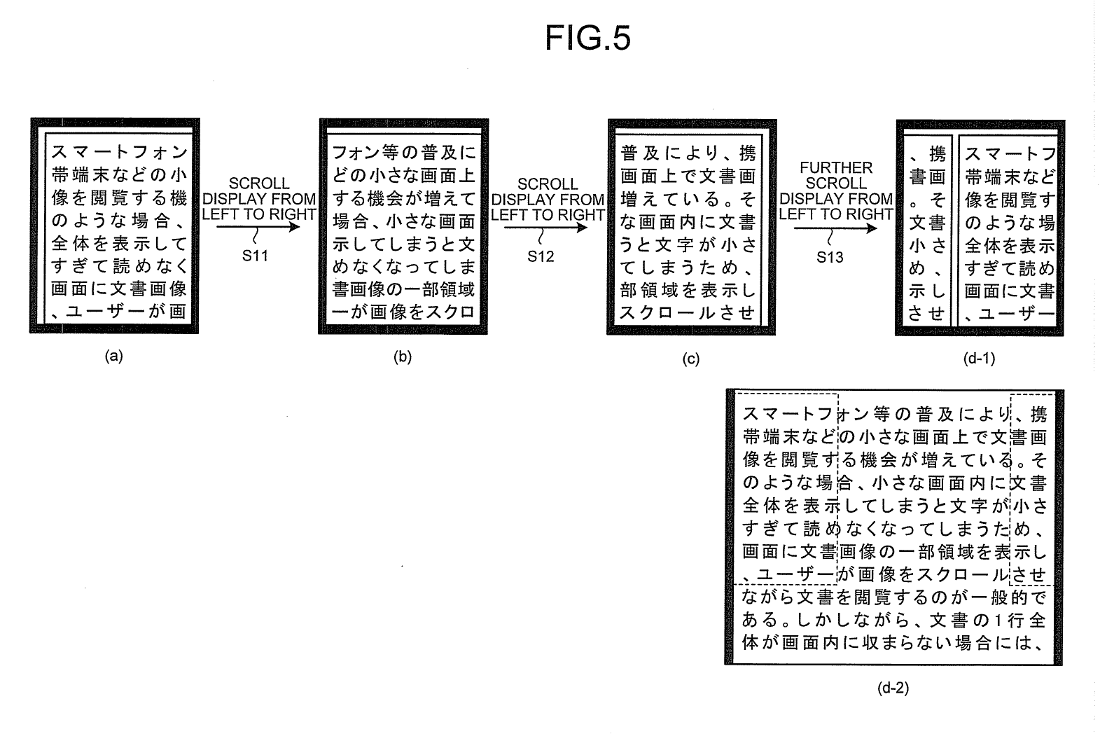

The following describes a scrolling method performed by the display processing device 10 in the first embodiment when the document data is browsed. FIG. 5 illustrates an example of the scrolling method performed by the display processing device 10 in the first embodiment when the document is browsed (in the right-left connection mode). The display processing device 10 in the first embodiment scrolls the display of the sentence area of interest from left to right in accordance with the user's operation to read a sentence (step S11). The display processing device 10 in the first embodiment further scrolls the display of the sentence area of interest from left to right in accordance with the user's operation to further read the sentence (step S12). The display processing device 10 in the first embodiment scrolls the display of the sentence area of interest from left to right in accordance with the user's operation to further read the sentence from the end of the first row to the beginning of the second row (step S13). The display processing device 10 in the first embodiment repeats the operations (from step S11 to step S13).

In the right-left connection mode, when the scrolling is further performed from left to right in the state illustrated in (c) in FIG. 5 after the document is read from the left end to the right end as illustrated in (a) to (c) in FIG. 5, the first display controller 17 performs a display in such a manner as if the right and left ends of the document data are connected (displays the first virtual document data). As a result, the area surrounded by the dotted line in (d-2) in FIG. 5 is displayed in such a manner that the beginnings of the rows are displayed on the right of the ends of the rows as illustrated in (d-1) in FIG. 5.

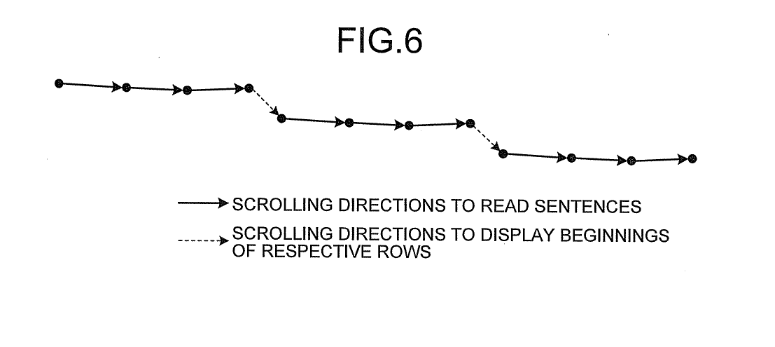

FIG. 6 is a schematic diagram for explaining traces of scrolling directions in the scrolling method described with reference to FIG. 5. The solid arrows indicate the scrolling directions to read sentences. The dotted arrows indicate the scrolling directions to display the beginnings of respective rows. As illustrated in FIG. 6, the display processing device 10 in the first embodiment can reduce the user's operation burden. In general, the scrolling manner illustrated in FIG. 6 probably causes the user's visual line to be constantly fixed near the central area of the screen. The display processing device 10 in the first embodiment, thus, can also reduce the user's burden due to shifting of the visual line. In addition, the scrolling can be readily automated by a system.

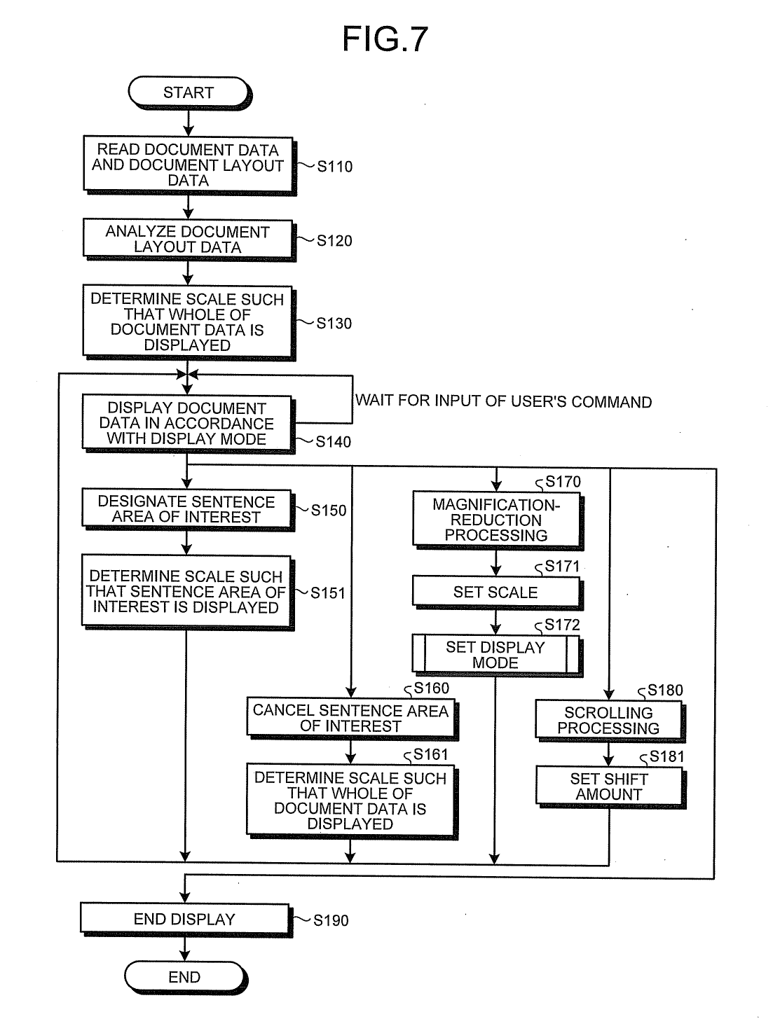

FIG. 7 is a flowchart for explaining a display method of the display processing device 10 in the first embodiment. The reader 13 reads the document data and the document layout data (step S110). An example of the document data is a document image in a raster format input from a scanner. The reader 13 may read a document not in a raster format, such as that in a hypertext markup language (HTML) format, converted into a raster image for screen display. The document layout data may be produced by the display processing device 10 or existing data may be used as the document layout data. For example, the display processing device 10 performs processing to produce the document layout data on a document image in a raster format input from a scanner. When the document data is an HTML document, the display processing device 10 may obtain the document layout data using an HTML rendering engine. When a document image is formed in an image format having other document layout data separately, the display processing device 10 uses the separately provided document layout data.

The analyzer 14 analyzes, from the document layout data, the document layout when the document data is displayed on the display 11 (step S120). The analyzer 14 extracts, on the basis of the document layout data, a title, paragraphs of sentences, and diagrams in a unit regarding them as collective components, and obtains the positions and the sizes of the respective components. The analyzer 14 identifies the types of respective components and further extracts relevant information. When the component includes sentences, the analyzer 14 extracts, for each row, the length and the height of the row, the character row direction, the reading order, and the positions and sizes of respective characters included in the row.

The display processing device 10 (the first display controller 17 or the second display controller 18) determines a scale such that the whole of the document data is displayed on the display 11 (step S130). The first display controller 17 performs the display control when the document is written horizontally. The second display controller 18 performs the display control when the document is written vertically. The display processing device 10 (the first display controller 17 or the second display controller 18) displays the document data in accordance with the display mode (step S140). When the processing proceeds from step S130 to step S140, the display processing device 10 displays the whole of the document data in the normal display mode. When displaying the whole of the document data, the display processing device 10 may display, together with the image, layout information obtained by the analysis of the document layout data. The layout information is a frame (rectangle) that clearly indicates the collective components including paragraphs of sentences or diagrams, for example.

After the processing proceeds from step S130 to step S140, the display processing device 10 (the first display controller 17 or the second display controller 18) performs processing in accordance with the user's operation (command). The user's operation using the display processing device 10 in the first embodiment includes designating the sentence area of interest (step S150), canceling the sentence area of interest (step S160), magnifying or reducing the displayed document data (step S170), scrolling the display (step S180), and ending the display (step S190).

The unit through which the user performs operation (the operation unit 15) may be any unit such as a keyboard, a stylus pen, a button, a mouse, or a touch panel. The display processing device 10 in the first embodiment may be a mobile terminal including a touch panel that functions as both of the display 11 and the operation unit 15, for example. In such a mobile terminal, the display content can be scrolled by sliding a finger over the touch panel.

The following describes the designation of the sentence area of interest (step S150). When the operation unit 15 receives the designation of the sentence area of interest from the user, the display processing device 10 (the first display controller 17 or the second display controller 18) determines a scale such that the sentence area of interest is displayed (step S151). When the sentences in the sentence area of interest are written horizontally, the first display controller 17 determines a scale such that the horizontal widths of the rows of the document fit the horizontal width of the screen of the display 11, and then the processing returns to step S140, at which the first display controller 17 displays the document data. When the sentences are written vertically, the second display controller 18 determines a scale such that the vertical widths of the rows of the document fit the vertical width of the screen of the display 11, and then the processing returns to step S140, at which the second display controller 18 displays the document data.

When the operation unit 15 receives the user's operation to cancel the sentence area of interest while the sentence area of interest is designated (step S160), the display processing device 10 in the first embodiment displays an initial state (displays the whole of the document data and the layout information). The display processing device 10 (the first display controller 17 or the second display controller 18) determines a scale such that the whole of the document data is displayed on the display 11 (step S161). The processing returns to step S140, at which the display processing device 10 (the first display controller 17 or the second display controller 18) displays the document data.

The operation unit 15 receives the user's operation to magnify or reduce the display (step S170). The magnification operation is performed by spreading two fingers apart on the touch panel, for example. The display processing device 10 (the first display controller 17 or the second display controller 18) renews the scale in accordance with the distance between the two spread fingers (step S171). The display processing device 10 (the first display controller 17 or the second display controller 18), then, sets the display mode (the normal display mode, the right-left connection mode, or the top-bottom connection mode) (step S172). The processing at step S172 is described later in detail. The processing returns to step S140, at which the display processing device 10 (the first display controller 17 or the second display controller 18) displays the document data in accordance with the display mode.

The operation unit 15 receives the user's operation to scroll the display (step S180). The scrolling operation is performed by sliding a finger over the touch panel so as to scroll the display, for example. The display processing device 10 (the first display controller 17 or the second display controller 18) renews a shift amount (movement amount) of the document data in accordance with the movement amount of the finger (step S181). The display processing device 10 (the first display controller 17 or the second display controller 18) moves the document data in the direction opposite to the movement direction of the finger. The processing returns to step S140, at which the display processing device 10 (the first display controller 17 or the second display controller 18) displays the document data in accordance with the shift amount and the display mode.

When the operation unit 15 receives the user's operation to end the display (step S190), the display processing device 10 (the first display controller 17 or the second display controller 18) ends the display processing.

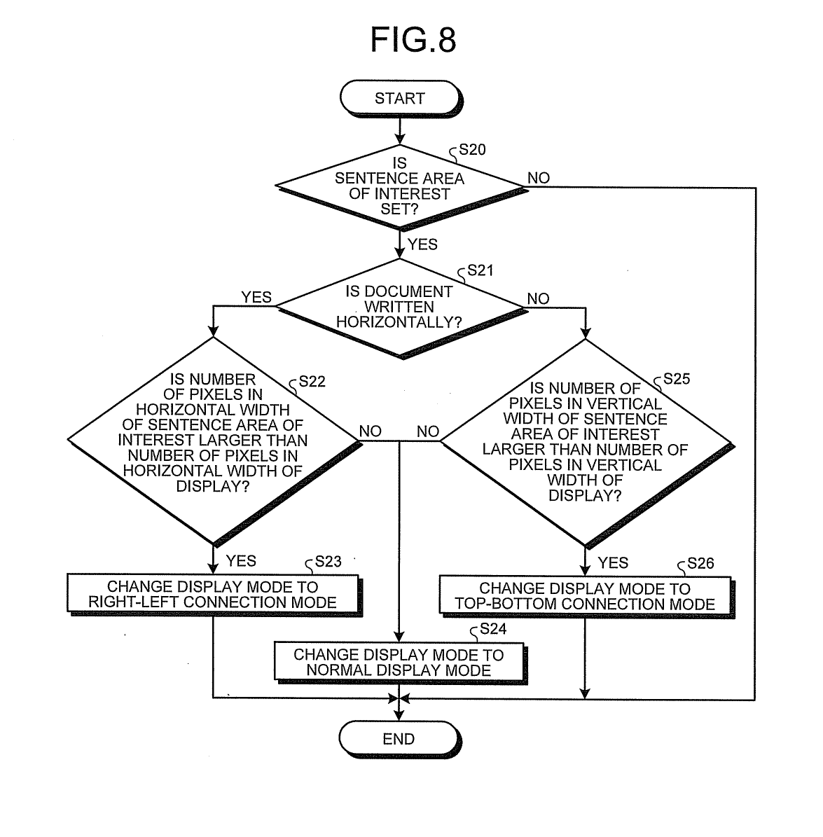

FIG. 8 is a flowchart for explaining a display mode setting method performed by the display processing device 10 in the first embodiment. The display mode in the initial state set by the display processing device 10 in the first embodiment is the normal display mode. The setting (renewal) of the display mode is performed at step S172 (refer to FIG. 7) by the operation to magnify or reduce the display as a trigger. The following describes the details of the display mode setting method.

The display processing device 10 determines whether the sentence area of interest is set (step S20). If the sentence area of interest is set (Yes at step S20), the processing proceeds to step S21. If no sentence area of interest is set (No at step S20), the processing ends without renewing the display mode. The display processing device 10 determines whether the sentences in the sentence area of interest are written horizontally (step S21). If the sentences are written horizontally (Yes at step S21), the processing proceeds to step S22. If the sentences are not written horizontally (are written vertically) (No at step S21), the processing proceeds to step S25.

The first display controller 17 determines whether the number of pixels in the horizontal width of the sentence area of interest is larger than the number of pixels in the horizontal width of the display 11 (step S22). If the number of pixels in the horizontal width of the sentence area of interest is larger than the number of pixels in the horizontal width of the display 11 (Yes at step S22), the first display controller 17 changes the display mode to the right-left connection mode (step S23). If the number of pixels in the horizontal width of the sentence area of interest is equal to or smaller than the number of pixels in the horizontal width of the display 11 (No at step S22), the first display controller 17 changes the display mode to the normal display mode (step S24).

The second display controller 18 determines whether the number of pixels in the vertical width of the sentence area of interest is larger than the number of pixels in the vertical width of the display 11 (step S25). If the number of pixels in the vertical width of the sentence area of interest is larger than the number of pixels in the vertical width of the display 11 (Yes at step S25), the second display controller 18 changes the display mode to the top-bottom connection mode (step S26). If the number of pixels in the vertical width of the sentence area of interest is equal to or smaller than the number of pixels in the vertical width of the display 11 (No at step S25), the second display controller 18 changes the display mode to the normal display mode (step S24).

The following describes an example of an algorithm to achieve the display mode in the display processing device 10 in the first embodiment.

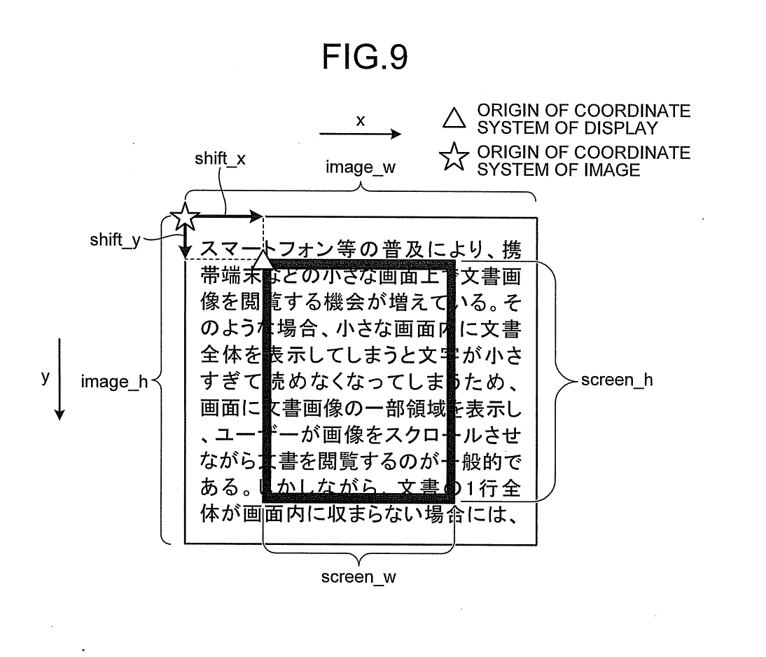

FIG. 9 is a schematic diagram for explaining a coordinate system of the display processing device 10 in the first embodiment. The horizontal width of the display 11 is defined as screen _w while the vertical width of the display 11 is defined as screen_h. The horizontal width of the sentence area of interest is defined as image_w while the vertical width of the sentence area of interest is defined as image_h. The horizontal width and the vertical width of the sentence area of interest are “zoom” times as large as those of the original image where a magnification-reduction rate is “zoom”. The sizes of scrolling amounts by the user's scrolling operation are defined as shift_x and shift_y. The coordinate systems of the display 11 and the sentence area of interest each have x and y axes and the origin at the upper left corner of the display, which are in common with each other.

The display mode is defined as draw_mode. The display mode is any one of the normal display mode defined as NORMAL_MODE, the right-left connection mode defined as LR_CONNECT_MODE, and the top-bottom connection mode defined as TB_CONNECT_MODE.

The display of a value of the pixel at coordinates (I, J) in the sentence area of interest on the pixel at coordinates (i, j) on the display screen is expressed as “SCREEN(i, j)←IMAGE(I, J)”. When the coordinates (I, J) are outside the image, a background color (e.g., black) is displayed.

A function f(k, wh) is defined as follows.

function f(k, wh){while (k<0) k←k+wh, while (k>wh) k←k−wh, return k}
If the value of k is negative, the value of wh is set to the value of k after the value of wh is added such that the value of k becomes positive, if the value of k is larger than the value of wh, the value of wh is set to the value of k after the value of wh is subtracted such that the value of k becomes equal to or smaller than the value of wh, and the value of k is a return value of the function.

In this case, SCREEN(i, j) is achieved as follows.
<NORMAL_MODE>
I←i+shift _x
J←j+shift_y
SCREEN(i, j)←IMAGE(I, J)
<LR_CONNECT_MODE>
I←f (i+shift_x, image_w)
J←j+shift_y
SCREEN(i, j)←IMAGE (I, J)
<TB_CONNECT_MODE>
I←i+shift_x
J←f (j+shift_y, image_h)
SCREEN(i, j)←IMAGE(I, J)

As described above, the display processing device 10 in the first embodiment can further reduce the user's burden due to shifting of the visual line and the scrolling operation than those caused by the conventional display processing device 10.

### Modifications of the First Embodiment

The display processing device 10 in the first embodiment performs the display processing method on the basis of that the content data is the document data and whether the document is written horizontally or vertically. The display processing may, however, be performed without determining whether the document is written horizontally or vertically. For example, as a modification of the display processing device 10 in the first embodiment, when the number of pixels in the width, which corresponds to the width of the display 11, of a display target area of content data is larger than the number of pixels in the width of the display 11, virtual content data may be displayed on the display 11. In the virtual content data, one end of the width, which corresponds to the width of the display 11, of the display target area and the other end opposite the one end of the width, which corresponds to the width of the display 11, of the display target area are connected. When such display control is performed, the control performed by the first display controller 17 and the second display controller 18 may be achieved by a single display controller.

As another modification of the display processing device 10 in the first embodiment, a connection display mode in which virtual content data is displayed and the normal display mode in which the content data is displayed without any change may be switched on the basis of a certain condition. The certain condition is any or a combination of the content of the content data, the document layout data of the content data, information about the user's operation, and setting of the display processing device 10. The virtual content data corresponds to the first virtual document data or the second virtual document data in the first embodiment. For example, the first display controller 17 may display the content data without any change in accordance with the user's operation even though the condition is satisfied to display the first virtual document data on the display 11.

### Second Embodiment

The following describes the display processing device 10 according to a second embodiment. The functional block of the display processing device 10 in the second embodiment is the same as that of the display processing device 10 in the first embodiment, and the detailed description thereof is, thus, omitted. The display processing device 10 in the second embodiment differs from the display processing device 10 in the first embodiment in display of the connection display mode (the right-left connection mode and the top-bottom connection mode).

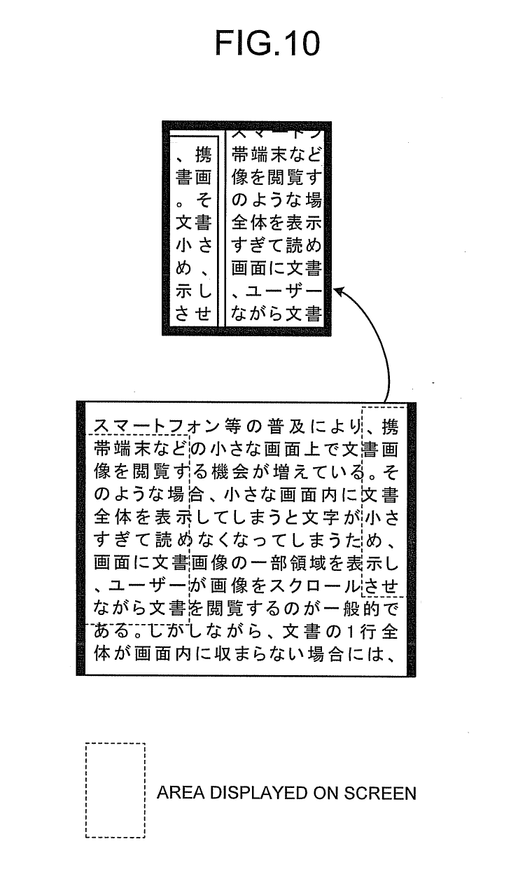

FIG. 10 is a schematic diagram for explaining an example of the right-left connection mode in the display processing device 10 in the second embodiment. As illustrated in FIG. 10, the first display controller 17 of the display processing device 10 in the second embodiment produces the first virtual document data such that the sentence of the nth row (n is an integer equal to or larger than one) at the right end and the sentence of the (n+1)th row at the left end are continuously connected when the right end and the left end are connected, and displays the produced first virtual document data. As a result, the display processing device 10 in the second embodiment can further reduce the user's burden due to shifting of the visual line and the scrolling operation.

When the document in the document data is written vertically, the second display controller 18 produces the second virtual document data such that the sentence of the nth column (n is an integer equal to or larger than one) at the bottom and the (n+1)th column at the top are connected when the bottom and the top are connected, and displays the produced second virtual document data.

As described above, the display processing device 10 in the second embodiment can further reduce the user's burden due to shifting of the visual line and the scrolling operation than those caused by the display processing device 10 in the first embodiment.

### Third Embodiment

The following describes the display processing device 10 according to a third embodiment. The functional block of the display processing device 10 in the third embodiment is the same as that of the display processing device 10 in the first embodiment, and the detailed description thereof is, thus, omitted. The display processing device 10 in the third embodiment further takes into consideration the display control when the document data includes a plurality of document blocks besides the display control performed by the display processing device 10 in the first embodiment.

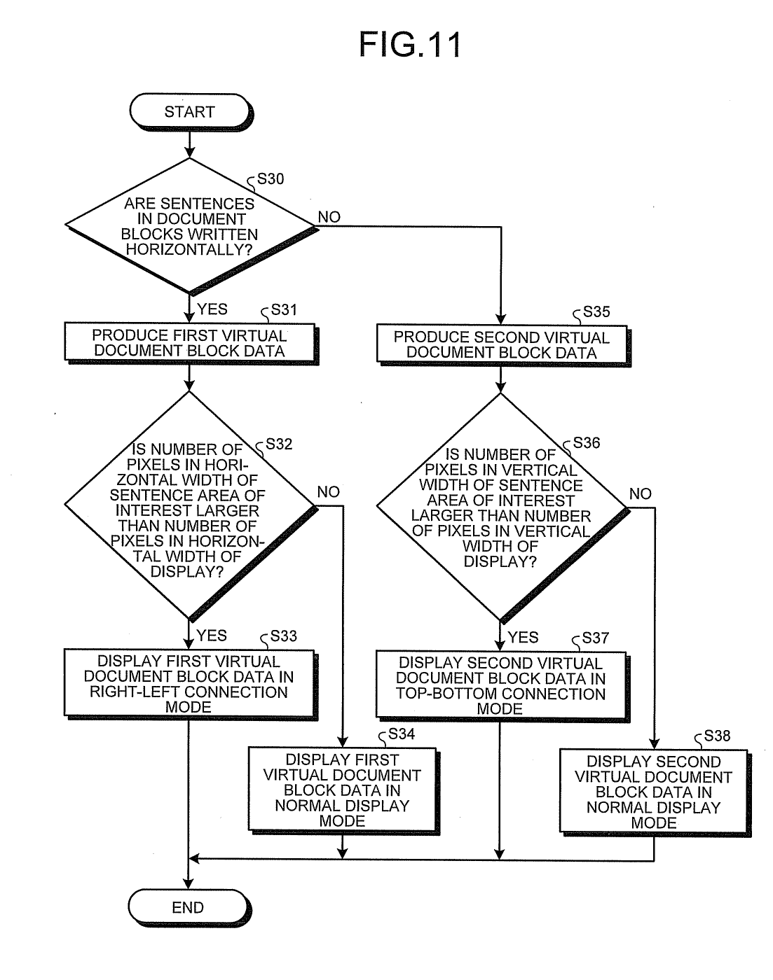

FIG. 11 is a flowchart for explaining a display method performed by the display processing device 10 in the third embodiment. The display processing device 10 determines whether the sentences in the document blocks included in the document data are written horizontally (step S30). If the sentences are written horizontally (Yes at step S30), the processing proceeds to step S31. If the sentences are not written horizontally (are written vertically) (No at step S30), the processing proceeds to step S35.

The first display controller 17 produces first virtual document block data in which the bottom of the Nth (N is an integer equal to or larger than one) document block and the top of the (N+1)th document block are connected (step S31). A method for determining the order of the document blocks included in the document data may be appropriately determined. For example, when the sentences in the document blocks are written horizontally, the order of the document blocks may be determined on the basis of the coordinates of the upper left corners of the respective document block areas. The first display controller 17 determines whether the number of pixels in the horizontal width of the sentence area of interest is larger than the number of pixels in the horizontal width of the display 11 (step S32). If the number of pixels in the horizontal width of the sentence area of interest is larger than the number of pixels in the horizontal width of the display 11 (Yes at step S32), the first display controller 17 changes the display mode to the right-left connection mode, and displays the first virtual document block data (step S33). If the number of pixels in the horizontal width of the sentence area of interest is equal to or smaller than the number of pixels in the horizontal width of the display 11 (No at step S32), the first display controller 17 changes the display mode to the normal display mode, and displays the first virtual document block data (step S34).

The second display controller 18 produces second virtual document block data in which the left end of the Nth (N is an integer equal to or larger than one) document block and the right end of the (N+1)th document block are connected (step S35). A method for determining the order of the document blocks included in the document data may be appropriately determined. For example, when the sentences in the document blocks are written vertically, the order of the document blocks may be determined on the basis of the coordinates of the upper right corners of the respective document block areas. The second display controller 18 determines whether the number of pixels in the vertical width of the sentence area of interest is larger than the number of pixels in the vertical width of the display 11 (step S36). If the number of pixels in the vertical width of the sentence area of interest is larger than the number of pixels in the vertical width of the display 11 (Yes at step S36), the second display controller 18 changes the display mode to the top-bottom connection mode, and displays the second virtual document block data (step S37). If the number of pixels in the vertical width of the sentence area of interest is equal to or smaller than the number of pixels in the vertical width of the display 11 (No at step S36), the second display controller 18 changes the display mode to the normal display mode, and displays the second virtual document block data (step S38).

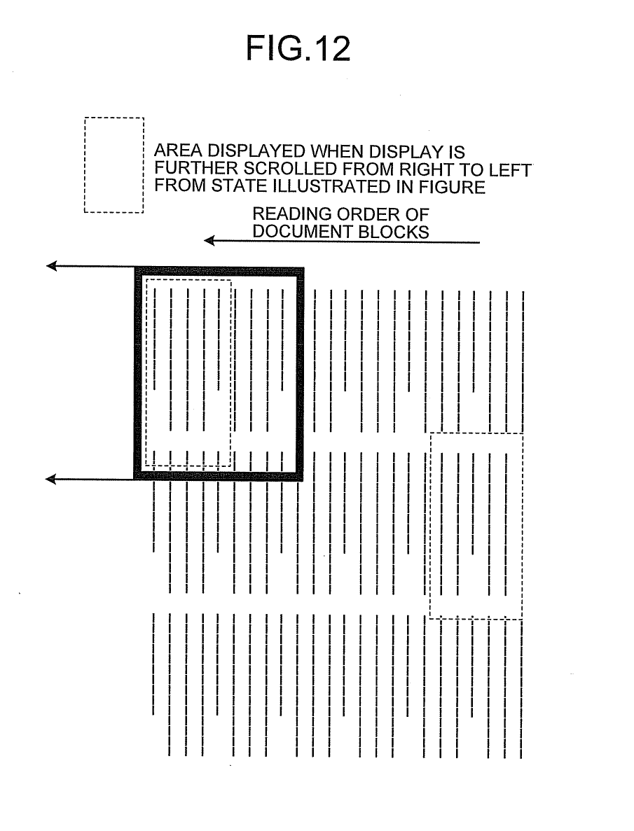

FIG. 12 is a schematic diagram for explaining an exemplary case where the display processing device 10 in the third embodiment displays the second virtual document block data in the right-left connection mode. In the example of the document data illustrated in FIG. 12, the document blocks are an upper block (the first document block), a middle block (the second document block), and a lower block (the third document block). The sentences in the document blocks are written vertically. The second display controller 18 produces the second virtual document block data in which the left end of the first document block and the right end of the second document block are connected, and the left end of the second document block and the right end of the third document block are connected. When the operation unit 15 detects operation to scroll the display from right to left from the state where the sentence area of interest is displayed as illustrated in FIG. 12, the second display controller 18 displays the area on the right end of the second document block.

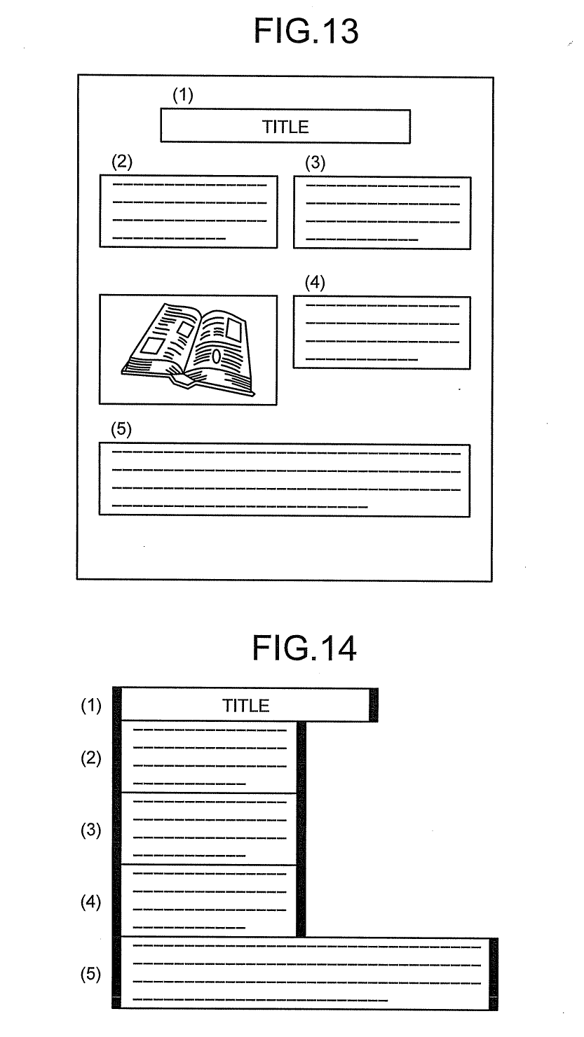

The following describes a specific example of the first virtual document block data. FIG. 13 illustrates an exemplary case where the sentences in the document blocks of the document data are written horizontally. FIG. 14 illustrates an example of the first virtual document block data (based on the document data illustrated in FIG. 13) produced by the display processing device 10 in the third embodiment. The first display controller 17 produces the first virtual document block data, and, then, switches the normal display mode and the right-left connection mode in accordance with the number of pixels in the horizontal width of the sentence area of interest of the first virtual document block data and the number of pixels in the horizontal width of the display 11. The control to display a plurality of document blocks having different horizontal widths simultaneously in the screen of the display 11 when the documents in the document blocks are written horizontally is described later.

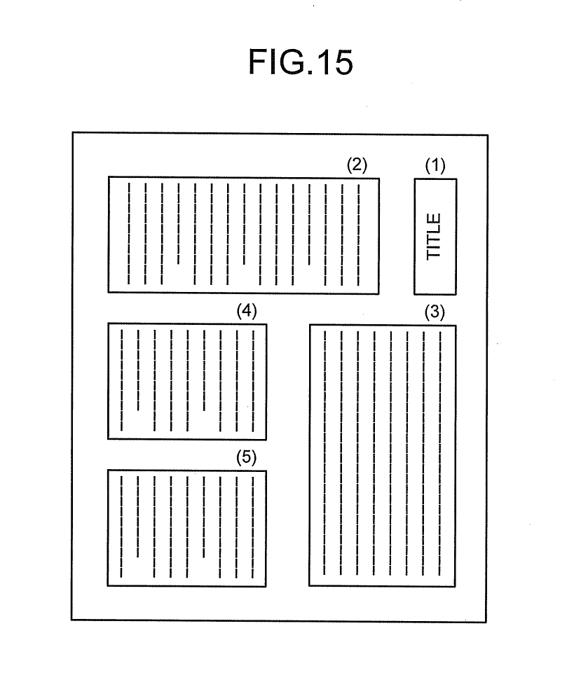

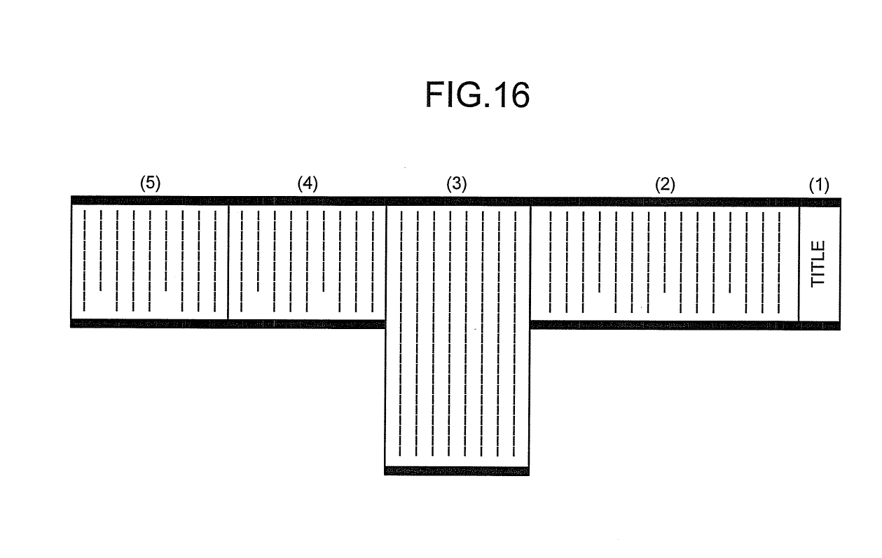

The following describes a specific example of the second virtual document block data. FIG. 15 illustrates an exemplary case where the sentences in the document blocks of the document data are written vertically. FIG. 16 illustrates an example of the second virtual document block data (based on the document data illustrated in FIG. 15) produced by the display processing device in the third embodiment. The second display controller 18 produces the second virtual document block data, and, then, switches the normal display mode and the top-bottom connection mode in accordance with the number of pixels in the vertical width of the sentence area of interest of the second virtual document block data and the number of pixels in the vertical width of the display 11. The control to display a plurality of document blocks having different vertical widths simultaneously in the screen of the display 11 when the documents in the document blocks are written vertically is described later.

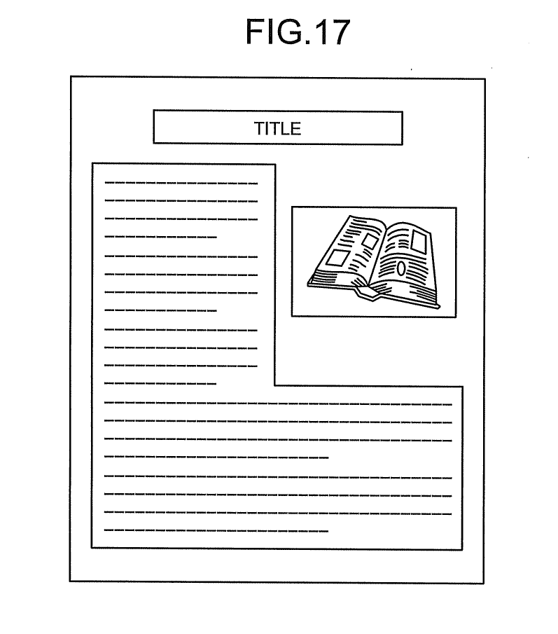

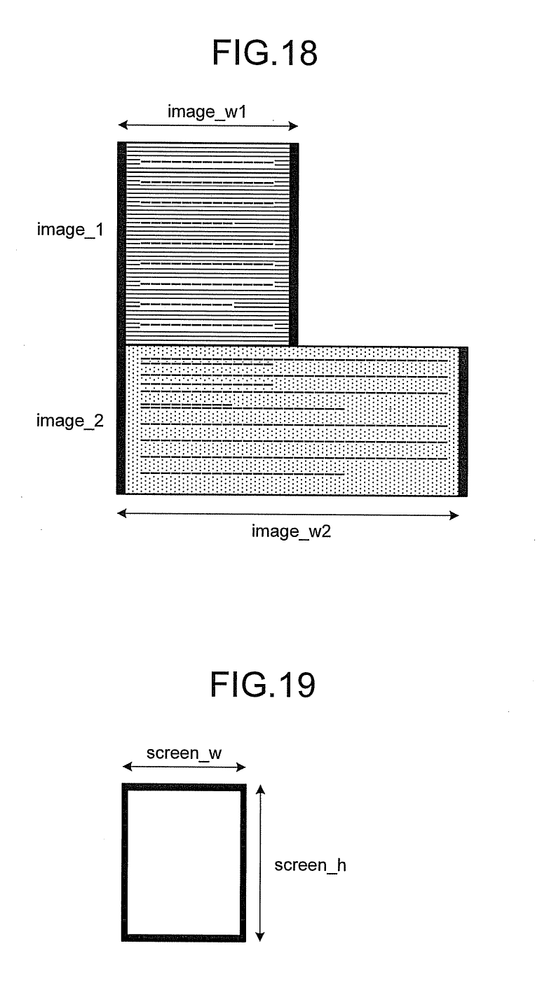

The following describes a case where the shape of the document block of the document data is not a rectangle. The following description is based on a case where the sentences in the document block are written horizontally. FIG. 17 illustrates an exemplary case where the shape of the document block of the document data is not a rectangle. FIG. 18 illustrates an example of the first virtual document block data (based on the document data illustrated in FIG. 17) produced by the display processing device in the third embodiment. As exemplarily illustrated in FIG. 18, the first display controller 17 divides the document block into a plurality of document blocks having a rectangular shape when the shape of the document block is not a rectangle. In the example illustrated in FIG. 18, the first display controller 17 divides the document block into an image_1 area and an image_2 area. The display state of the screen is changed, by screen scrolling, to the following three states: a state where only the image_1 area is displayed, a state where the image_1 area and the image_2 area are displayed, and a state where only the image_2 area is displayed. The states where only the image_1 area is displayed and only the image_2 area is displayed are the same as the case where a single document block having a rectangular shape is displayed. In the state where the image_1 area and the image_2 area are displayed, the first display controller 17 controls a method for displaying the document blocks on the screen on the basis of the size of the screen of the display 11 and a change in length of the horizontal width of an attention display area. The following describes a case where a plurality of document blocks having different horizontal widths are displayed simultaneously in the screen of the display 11 when the documents in the document blocks are written horizontally.

The screen of the display 11 is described. FIG. 19 is a schematic diagram illustrating an example of the size of the display 11 of the display processing device 10 in the third embodiment. In the example illustrated in FIG. 19, the size of the vertical width of the display 11 is defined as screen_h, while the size of the horizontal width of the display 11 is defined as screen_w.

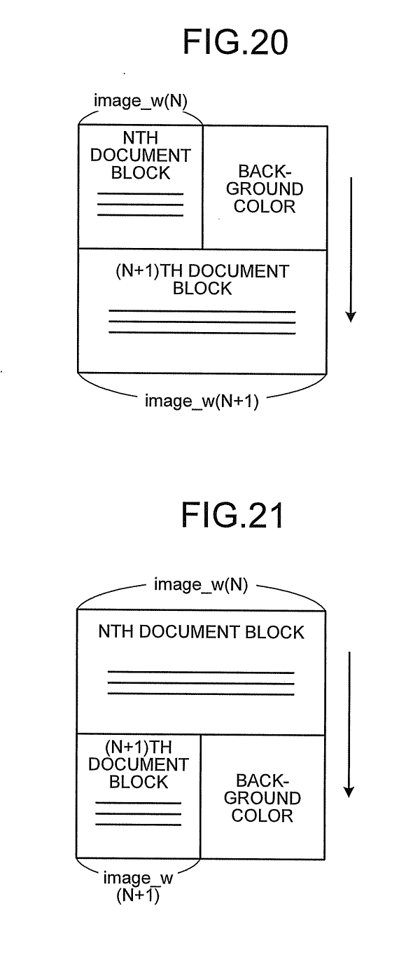

FIG. 20 illustrates an example where a plurality of document blocks having different horizontal widths are simultaneously displayed when the display processing device 10 in the third embodiment displays the first virtual document block data. In the display example illustrated in FIG. 20, the Nth document block (N is an integer equal to or larger than one) and the (N+1)th document block are simultaneously displayed. In the example, a horizontal width size “image_w(N+1)” of the (N+1)th document block is larger than a horizontal width size “image_w(N)” of the Nth document block. In other words, this is a case where the horizontal width of the document block to be displayed next to the presently displayed document block is larger than that of the presently displayed document block when the display is scrolled from top to bottom.

The first display controller 17 produces the first virtual document block data using, as a unit area of connection, the rectangle circumscribing the Nth document block and the (N+1)th document block. The first display controller 17 sets the Nth document block to the left end of the unit area. The first display controller 17 displays a background color on the area in which neither the Nth document block nor the (N+1)th document block is provided in the unit area. Any color such as black or gray may be used as the background color. The first display controller 17 displays the document blocks in the normal display mode when the horizontal width of the first virtual document block data in FIG. 20 is equal to or smaller than screen_w. The first display controller 17 displays the document blocks in the right-left connection mode when the horizontal width of the first virtual document block data in FIG. 20 is larger than screen_w.

FIG. 21 illustrates another example where a plurality of document blocks having different horizontal widths are simultaneously displayed when the display processing device 10 in the third embodiment displays the first virtual document block data. In the display example illustrated in FIG. 21, the Nth document block (N is an integer equal to or larger than one) and the (N+1)th document block are simultaneously displayed. In the example, the horizontal width size “image_w(N+1)” of the (N+1)th document block is smaller than the horizontal width size “image_w(N)” of the Nth document block. In the example, max(image_w(N), image_w(N+1)), that is the size of the larger out of image_w(N) and image_w(N+1), is equal to or smaller than screen_w. In other words, this is a case where the horizontal width of the document block to be displayed next to the presently displayed document block is smaller than that of the presently displayed document block when the display is scrolled from top to bottom. In the example, the horizontal width size of the first virtual document block data is equal to or smaller than the horizontal width size of the display 11.

The first display controller 17 produces the first virtual document block data using, as a unit area of connection, the rectangle circumscribing the Nth document block and the (N+1)th document block. The first display controller 17 sets the (N+1)th document block to the left end of the unit area. The first display controller 17 displays a background color on the area in which neither the Nth document block nor the (N+1)th document block is provided in the unit area. Any color such as black or gray may be used as the background color. The first display controller 17 displays the first virtual document block data in FIG. 21 in the normal display mode. The first display controller 17 may display the (N+1)th document block by magnifying (e.g., by screen_w/image_w times) without displaying the background color.

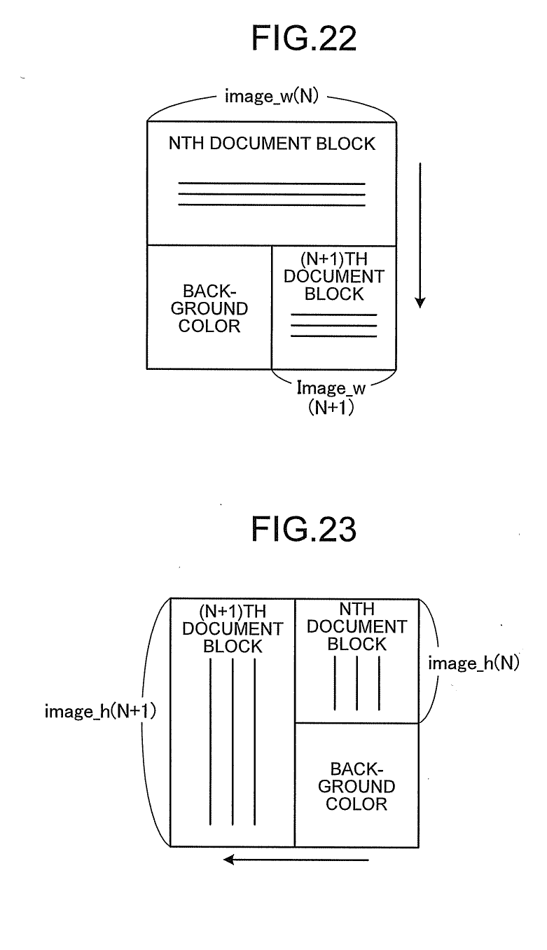

FIG. 22 illustrates still another example where a plurality of document blocks having different horizontal widths are simultaneously displayed when the display processing device 10 in the third embodiment displays the first virtual document block data. In the display example illustrated in FIG. 22, the Nth document block (N is an integer equal to or larger than one) and the (N+1)th document block are simultaneously displayed. In the example, the horizontal width size “image_w(N+1)” of the (N+1)th document block is smaller than the horizontal width size “image_w(N)” of the Nth document block. In the example, max (image_w(N), image_w(N+1)), that is the size of the larger out of image_w(N) and image_w(N+1), is larger than screen_w. In other words, this is a case where the horizontal width of the document block to be displayed next to the presently displayed document block is smaller than that of the presently displayed document block when the display is scrolled from top to bottom. In the example, the horizontal width size of the first virtual document block data is larger than the horizontal width size of the display 11.

The first display controller 17 produces the first virtual document block data using, as a unit area of connection, the rectangle circumscribing the Nth document block and the (N+1)th document block. The first display controller 17 sets the (N+1)th document block to the right end of the unit area. The first display controller 17 displays a background color on the area in which neither the Nth document block nor the (N+1)th document block is provided in the unit area. Any color such as black or gray may be used as the background color. The first display controller 17 displays the first virtual document block data in FIG. 22 in the right-left connection mode.

FIG. 23 illustrates an example where a plurality of document blocks having different vertical widths are simultaneously displayed when the display processing device 10 in the third embodiment displays the second virtual document block data. In the display example illustrated in FIG. 23, the Nth document block (N is an integer equal to or larger than one) and the (N+1)th document block are simultaneously displayed. In the example, a vertical width size “image_h(N+1)” of the (N+1)th document block is larger than a vertical width size “image_h(N)” of the Nth document block. In other words, this is a case where the vertical width of the document block to be displayed next to the presently displayed document block is larger than that of the presently displayed document block when the display is scrolled from right to left.

The second display controller 18 produces the second virtual document block data using, as a unit area of connection, the rectangle circumscribing the Nth document block and the (N+1)th document block. The second display controller 18 sets the Nth document block to the top of the unit area. The second display controller 18 displays a background color on the area in which neither the Nth document block nor the (N+1)th document block is provided in the unit area. Any color such as black or gray may be used as the background color. The second display controller 18 displays the document blocks in the normal display mode when the vertical width of the second virtual document block data in FIG. 23 is equal to or smaller than screen_h. The second display controller 18 displays the document blocks in the top-bottom connection mode when the vertical width of the second virtual document block data in FIG. 23 is larger than screen_h.

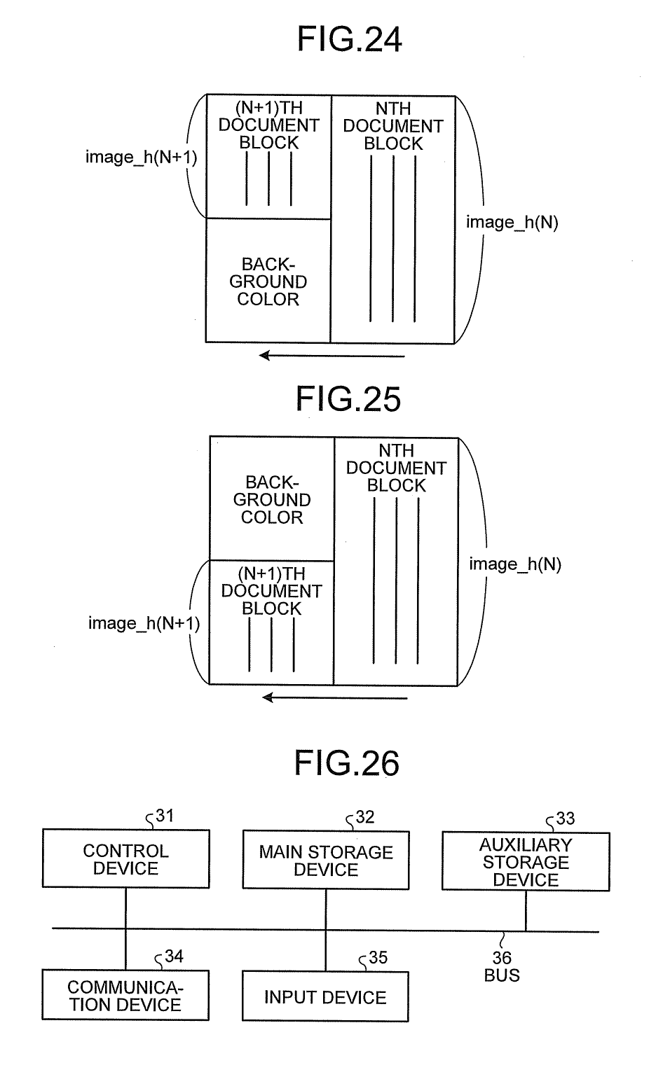

FIG. 24 illustrates another example where a plurality of document blocks having different vertical widths are simultaneously displayed when the display processing device 10 in the third embodiment displays the second virtual document block data. In the display example illustrated in FIG. 24, the Nth document block (N is an integer equal to or larger than one) and the (N+1)th document block are simultaneously displayed. In the example, the vertical width size “image_h(N+1)” of the (N+1)th document block is smaller than the vertical width size “image_h(N)” of the Nth document block. In the example, max(image_h(N), image_h(N+1)) is equal to or smaller than screen_h where max(image_h(N), image_h(N+1)) is the size of the larger one either the vertical width size “image_h(N)” or the vertical width size “image_h(N+1)”. In other words, this is a case where the vertical width of the document block to be displayed next to the presently displayed document block is smaller than that of the presently displayed document block when the display is scrolled from right to left. In the example, the vertical width size of the second virtual document block data is equal to or smaller than the vertical width size of the display 11.

The second display controller 18 produces the second virtual document block data using, as a unit area of connection, the rectangle circumscribing the Nth document block and the (N+1)th document block. The second display controller 18 sets the (N+1)th document block to the top of the unit area. The second display controller 18 displays a background color on the area in which neither the Nth document block nor the (N+1)th document block is provided in the unit area. Any color such as black or gray may be used as the background color. The second display controller 18 displays the second virtual document block data in FIG. 24 in the normal display mode. The second display controller 18 may display the (N+1)th document block by magnifying (e.g., by screen_h/image_h times) without displaying the background color.

FIG. 25 illustrates still another example where a plurality of document blocks having different vertical widths are simultaneously displayed when the display processing device 10 in the third embodiment displays the second virtual document block data. In the display example illustrated in FIG. 25, the Nth document block (N is an integer equal to or larger than one) and the (N+1)th document block are simultaneously displayed. In the example, the vertical width size “image_h(N+1)” of the (N+1)th document block is smaller than the vertical width size “image_h(N)” of the Nth document block. In the example, max (image_h(N), image_h(N+1)), that is the size of the larger out of image_h(N) and image_h(N+1), is larger than screen_h. In other words, this is a case where the vertical width of the document block to be displayed next to the presently displayed document block is smaller than that of the presently displayed document block when the display is scrolled from right to left. In the example, the vertical width size of the second virtual document block data is larger than the vertical width size of the display 11.

The second display controller 18 produces the second virtual document block data using, as a unit area of connection, the rectangle circumscribing the Nth document block and the (N+1)th document block. The second display controller 18 sets the (N+1)th document block to the bottom of the unit area. The second display controller 18 displays a background color on the area in which neither the Nth document block nor the (N+1)th document block is provided in the unit area. Any color such as black or gray may be used as the background color. The second display controller 18 displays the second virtual document block data in FIG. 25 in the top-bottom connection mode.

As described above, the display processing device 10 in the third embodiment can reduce the user's burden due to shifting of the visual line and the scrolling operation even when a plurality of document blocks are displayed on the display 11.

FIG. 26 illustrates an example of main components of a hardware structure of the display processing device 10 in the first to the third embodiments. The display processing device 10 in the first to the third embodiments includes a control device 31, a main storage device 32, an auxiliary storage device 33, a communication device 34, and an input device 35. The control device 31, the main storage device 32, the auxiliary storage device 33, the communication device 34, and the input device 35 are connected to one another via a bus 36.

The control device 31 executes a program read in the main storage device 32 from the auxiliary storage device 33. The main storage device 32 is a memory such as a read only memory (ROM) or a random access memory (RAM). The auxiliary storage device 33 is a memory card, for example. The input device 35 is an interface through which the display processing device 10 is operated. The communication device 34 is an interface that connects the display processing device 10 to a network.

The program executed by the display processing device 10 in the first to the third embodiments may be recorded on a computer-readable storage medium such as a compact disc read only memory (CD-ROM), a flexible disk (FD), a compact disc recordable (CD-R), and a digital versatile disc (DVD), as an installable or executable file, and provided as a computer program product. The program executed by the display processing device 10 in the first to the third embodiments may be stored in a computer connected to a network such as the Internet, and be provided by downloading the program via the network. The program executed by the display processing device 10 in the first to the third embodiments may be provided or distributed via a network such as the Internet. The program executed by the display processing device 10 in the first to the third embodiments may be embedded and provided in a ROM, for example.

The program executed by the display processing device 10 in the first to the third embodiments has a module structure including the functional blocks achievable by the program out of the functional blocks illustrated in FIG. 1. In actual hardware, the control device 31 reads the program from the storage medium and executes the program. As a result, the respective modules are loaded in the main storage device 32. The respective modules are formed in the main storage device 32. A part or the whole of the respective functional blocks illustrated in FIG. 1 may be achieved by hardware such as an integrated circuit (IC) without using the program.

As described above, the display processing device 10 including the first display controller 17 and the second display controller 18 in the first to the third embodiments can further reduce the user's burden due to shifting of the visual line and scrolling operation than the burden caused by the conventional display processing device 10.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display processing device comprising:
a reader configured to read content data that is to be displayed on a display; and
a display controller configured to display, on the display, virtual content data in which one end of a display target area of the content data and the other end opposite to the one end of the display target area are connected, when a width of the display target area is larger than a width of the display.

2. The display processing device according to claim 1, wherein the content data is document data that indicates data including a document.

3. The display processing device according to claim 2, wherein
the display controller displays, on the display, virtual document data in which a right end and a left end of the display target area are connected when the document included in the document data is written horizontally, and
the display controller displays, on the display, virtual document data in which a top and a bottom of the display target area are connected when the document included in the document data is written vertically.

4. The display processing device according to claim 1, wherein the display controller has a connection display mode in which the virtual content data is displayed and'a normal display mode in which the content data is displayed without connection, and switches between the connection display mode and the normal display mode on the basis of a certain condition.

5. The display processing device according to claim 2, wherein the display controller produces virtual document data such that an end of an nth row continues to a beginning of an (n+1)th row when the content data has a row structure, the display controller produces virtual document data such that an end of an nth column continues to a beginning of an (n+1)th column when the content data has a column structure, n being an integer equal to or larger than one.

6. The display processing device according to claim 4, wherein the display controller produces virtual document data such that an end of an nth row continues to a beginning of an (n+1)th row when the content data has a row structure, the display controller produces virtual document data such that an end of an nth column continues to a beginning of an (n+1)th column when the content data has a column structure, n being an integer equal to or larger than one.

7. The display processing device according to claim 2, wherein the display controller produces virtual document data in which an nth document block and an (n+1) document block are connected when the content data is composed of a plurality of document blocks, n being an integer equal to or larger than one.

8. The display processing device according to claim 4, wherein the display controller produces virtual document data in which an nth document block and an (n+1) document block are connected when the content data is composed of a plurality of document blocks, n being an integer equal to or larger than one.

9. The display processing device according to claim 1, wherein
the content data is document data that indicates data including a document, and
the display controller includes a first display controller configured to display, on the display, first virtual document data in which a right end and a left end of the document data are connected in a case where the number of pixels in a horizontal width of the display target area of the document data is larger than the number of pixels in a horizontal width of the display and the document included in the document data is written horizontally.

10. The display processing device according to claim 9, wherein the first display controller produces the first virtual document data such that the right end of the nth row and the left end of the (n+1)th row are continuously connected when the right end and the left end are connected, n being an integer equal to or larger than one.

11. The display processing device according to claim 9, wherein the first display controller produces first virtual document block data in which a bottom of an Nth document block and a top of an (N+1) document block are connected, and displays, on the display, the first virtual document data in which the right end and the left end of the first virtual document block data are connected when the document is composed of a plurality of document blocks and the documents included in the document blocks are written horizontally, N being an integer equal to or larger than one.

12. The display processing device according to claim 9, wherein, when an (N+1)th document block having a larger number of pixels in a horizontal width than the number of pixels in a horizontal width of an Nth document block is displayed from a state where the Nth document block is displayed on the display, and the Nth document block and the (N+1)th document block are simultaneously displayed, the first display controller produces the first virtual document block data using, as a unit area of connection, a rectangle circumscribing the Nth document block and the (N+1)th document block, sets the Nth document block to a left end of the unit area, and displays a background color on an area in which neither the Nth document block nor the (N+1)th document block is provided, N being an integer equal to or larger than one.

13. The display processing device according to claim 9, wherein, when an (N+1)th document block having a smaller number of pixels in a horizontal width than the number of pixels in a horizontal width of an Nth document block is displayed from a state where the Nth document block is displayed on the display, and the Nth document block and the (N+1)th document block are simultaneously displayed, the first display controller produces the first virtual document block data using, as a unit area of connection, a rectangle circumscribing the Nth document block and the (N+1)th document block, sets the (N+1)th document block to a right end of the unit area, and displays a background color on an area in which neither the Nth document block nor the (N+1)th document block is provided, N being an integer equal to or larger than one.

14. The display processing device according to claim 1, wherein
the content data is document data that indicates data including a document, and
the display controller includes a second display controller configured to display, on the display, second virtual document data in which a top and a bottom of the document data are connected in a case where the number of pixels in a vertical width of the display target area of the document data is larger than the number of pixels in a vertical width of the display and the document included in the document data is written vertically.

15. The display processing device according to claim 14, wherein the second display controller produces the second virtual document data such that the bottom of an nth column and the top of an (n+1)th column are continuously connected when the top and the bottom are connected, n being an integer equal to or larger than one.

16. The display processing device according to claim 14, wherein the second display controller produces second virtual document block data in which a left end of an Nth document block and a right end of an (N+1) document block are connected, and displays, on the display, the second virtual document data in which a top and a bottom of the second virtual document block data are connected when the document is composed of a plurality of document blocks and the documents included in the document blocks are written vertically, N being an integer equal to or larger than one.

17. The display processing device according to claim 14, wherein, when an (N+1)th document block having a larger number of pixels in a vertical width than the number of pixels in a vertical width of an Nth document block is displayed from a state where the Nth document block is displayed on the display and the Nth document block and the (N+1)th document block are simultaneously displayed, the second display controller produces the second virtual document block data using, as a unit area of connection, a rectangle circumscribing the Nth document block and the (N+1)th document block, sets the Nth document block to a top of the unit area, and displays a background color on an area in which neither the Nth document block nor the (N+1)th document block is provided, N being an integer equal to or larger than one.

18. The display processing device according to claim 14, wherein, when an (N+1)th document block having a smaller number of pixels in a vertical width than the number of pixels in a vertical width of an Nth document block is displayed from a state where the Nth document block is displayed on the display and the Nth document block and the (N+1)th document block are simultaneously displayed, the second display controller produces the second virtual document block data using, as a unit area of connection, a rectangle circumscribing the Nth document block and the (N+1)th document block, sets the (N+1)th document block to a bottom of the unit area, and displays a background color on an area in which neither the Nth document block nor the (N+1)th document block is provided, N being an integer equal to or larger than one.

19. A display processing method comprising:
reading content data that is to be displayed on a display; and
displaying, on the display, virtual content data in which one end of a width of a display target area of the content data and the other end opposite to the one end of the display target area are connected, when a width of the display target area is larger than a width of the display.

20. A computer program product comprising a computer-readable medium containing a program executed by a computer, the program causing the computer to execute:
reading content data that is to be displayed on a display; and
displaying, on the display, virtual content data in which one end of a width of a display target area of the content data and the other end opposite to the one end of the display target area are connected, when a width of the display target area is larger than a width of the display.
